(19) United States
(12) Patent Application Publication
(10) Pub. No.: US 2018/0153329 A1
(43) Pub. Date: Jun. 7, 2018

(54) PRESSURE COOKING APPLIANCE

(71) Applicant: Dov Z. Glucksman, Winchester, MA (US)

(72) Inventors: Dov Z. Glucksman, Winchester, MA (US); Andrew Joseph Rojee, Norfolk, MA (US); Michael David Miller, Tewksbury, MA (US)

(21) Appl. No.: 15/828,291

(22) Filed: Nov. 30, 2017

Related U.S. Application Data
(63) Continuation of application No. 62/547,909, filed on Aug. 21, 2017.
Application No. 62/547,909 is a continuation of application No. 62/446,579, filed on Jan. 16, 2017.
Application No. 62/446,579 is a continuation of application No. 62/428,623, filed on Dec. 1, 2016.

(51) Int. Cl. A47J 27/08

(52) U.S. Cl. CPC A47J 27/0815; A47J 27/0811

(57) ABSTRACT

An oval shaped countertop kitchen appliance having a cooking chamber that defines a cavity. The cooking chamber has a rim defining an opening to the cavity. An electric heating element is disposed proximate the cavity to heat the cavity. A pan retaining foodstuff therein has a generally hollow interior and a rim defining an opening for accessing the interior thereof. The pan is sized and shaped to fit within the cavity of the cooking chamber. A lid is sized and shaped to at least partially cover the cooking chamber rim when placed on the cooking chamber rim. At least one hinge and one latch are mounted to one of the exterior surface of the side wall of the cooking chamber and the lid. A pressure seal is present in the interface of the lid and the cooking chamber rim. Said pressure seal is compressed when latching mechanism is in its latched position. Pressure regulating valve communicates between the cooking chamber cavity and the outside, to limit the pressure built up within the cooking chamber as foodstuff is heated by said electric heater and emits steam during the cooking process. Said cooking pressure is set at a predetermined level. Temperature in the cooking chamber is controllable by the user as is the duration of the cooking cycle.

### RELATED APPLICATION

This application claims the benefit of U.S. Provisional Applications No. 62/428,623 filed on 1 Dec. 2016, No. 62/446,579 filed on 16 Jan. 2017, and No. 62/547,909 filed on 21 Aug. 2017, the teachings of which are all claimed herein by reference in their entireties.

### FIELD OF THE INVENTION

This invention relates generally to kitchen appliances, and more particularly to a countertop cooker where food can be cooked at high temperatures under a slightly elevated pressure.

### BACKGROUND

Kitchen appliances, such as slow cookers and counter top roasters, are well known. Conventional slow cookers and roasters are generally elongated or oval, as they are used, for example for roasting a whole turkey or a large chicken, or a rack of ribs. On the other hand, pressure cookers, where food is cooked under relatively high-pressure conditions ranging from 10 to 20 psi (0.7 to 1.5 bar) have a round lid, primarily since it is much easier to seal a round perimeter than an elongated one.

Another major difference between roasters and pressure cookers is the temperature at which the food is being cooked: pressure cookers reach internal temperatures of approximately 120 degrees Centigrade (248 F), roasters are designed to reach internal cooking temperatures of 250 C (482 F).

These higher temperatures are required to roast food such as chicken, turkey, pork or beef where the outer layer must be crisp and browned, something that cannot be achieved by cooking in a pressure cooker.

It was determined from experiments that maintaining a positive pressure in an elongated, or oval cooking appliance such as those of the prior art was not possible due to pressure leakage. Converting a prior art oval cooking appliance into a pressure cooker by the addition of any prior art pressure cooker lid-clamping arrangement was found to allow loss of the desired pressure. Through exhaustive experimentation, the clamping system disclosed herein was found to provide adequate pressure retention by securing the lid at multiple points around its periphery to obtain a full and even seal. It was also determined through exhaustive experimentation that to simplify the user experience with the appliance, the lid should be hingeable, and that the hinges should provide a downward pressure when the lid is closed. It was also determined from exhaustive experimentation that the lid should be secured at its two ends to prevent the lid from bending under the realized pressure. It was also found necessary that opening of the lid should be prevented when there is a positive pressure in the cooking compartment, to avoid hot air and steam escaping which might scald the user.

Comparison tests were conducted to determine the results of cooking chicken in an array of prior art cookers and a cooker according to this disclosure (“Pressurized Roaster 12-qt”). Those results appear in the following table:

Pressure Cooking Comparison Testing
Project #103-131 Date: Jun. 16, 2016 Room Barometer Reading = 29.7 inches
Room Relative Humidity = 49% Room Temperature = 22 C.
Assorted BBQ Chicken Pieces Recipe

| | | | | | Cooking | Pressure | | Internal |
|---|---|---|---|---|---|---|---|---|
| Test | | | | | Time | Applied? | | Chicken Temp. |
| # | Model | Voltage | Wattage | Amperage | (minutes) | (Y/N) | PSI | (Degrees F.) |
| 1 | Wolfgang Puck | 120 v | 1650 | 13.5 | 32 | N | atmospheric | 170-175 |
| | Pressure Oven | | | | | | | |
| 2 | Wolfgang Puck | 120 v | 1650 | 13.5 | 26 | Y | 1-1.5 | 163-170 |
| | Pressure Oven | | | | | | | |
| 3 | Hamilton Beach | 120 v | 1500 | 12.5 | 31 | N | atmospheric | 170 |
| | Model 31101 | | | | | | | |
| 4 | Nesco Convection | 120 v | 1110 | 9.05 | 60 | N | atmospheric | 170-175 |
| | roaster 12 qt | | | | | | | |
| 5 | Nesco Convection | 120 v | 1115 | 9.15 | 45 | N | atmospheric | 175-180 |
| | roaster 12 qt | | | | | | | |
| 6 | Pressurized | 120 v | 1300 | 10.66 | 19 | Y | 1.3 | 180 |
| | Roaster 12 qt | | | | | | | |

From these results it can be seen an ideal Internal Chicken Temperature was achieved in far less time using a cooker according to the invention than with any of the prior art cookers.

There is therefore a need, and it is an object of the invention to provide an elongated or oval shaped electric countertop cooking appliance which maintains a slightly elevated pressure and high temperature. There is a further need, and it is a further object, that the slightly elevated pressure ranges from 1 psi to 2.5 psi (0.07-0.18 bar) without leaking. There is a further need, and it is a further object, that the high temperature is approximately 250 C (482 F).

The foregoing examples of the related art and limitations related therewith are intended to be illustrative and not exclusive. The limitations of the related art will become apparent to those skilled in the art upon a reading of the specification and a study of the drawings.

### SUMMARY OF THE INVENTION

The invention may be embodied in or practiced using a countertop kitchen appliance having a cooking chamber with a side wall and a first rim defining a first opening to a cavity, an electric heating element disposed proximate the cavity to heat the cavity, a lid sized and shaped to cover the first rim when placed there-on, one or more hinges pivotably connecting the lid to the sidewall and enabling the lid to pivot between an opened position for accessing the cavity and a closed position for covering the cavity, one or more latches for voluntarily securing the lid to the side wall, each having an unlatched position for allowing the lid to pivot relative to the sidewall, and a latched position for engaging the lid to the sidewall in the closed position, a pressure seal disposed between the lid and the first rim and compressed there-between when the lid is in the closed position and the latch is in the latched position, and a pressure-regulating valve communicating between the cavity and an exterior environment and adapted to prevent pressure within the cavity from exceeding a first predetermined pressure level relative to the exterior environment.

The appliance may further have a pressure responsive lock for involuntarily securing the lid in the closed position when the pressure within the cavity exceeds a second predetermined pressure level. The appliance may include a pan sized and shaped to fit within the cavity and having a generally hollow interior and a second rim defining a second opening for accessing the generally hollow interior. The one or more latches may be at least two latches, and the one or more hinges and at least two latches may be approximately equally spaced about the first rim. The appliance may have a control for maintaining the heating of the cavity at a predetermined temperature level. The pressure-regulating valve may be adjustable to vary the predetermined pressure level. The appliance may be longer from a left side to a right side than from a front side to a rear side. The at least two latches may be two latches disposed adjacent the left and right sides and the one or more hinges may be disposed on the front side.

The invention may alternatively be embodied in or practiced using a countertop kitchen appliance having a cooking chamber having a side wall and a first rim defining a first opening to a cavity, an electric heating element disposed proximate the cavity to heat the cavity, a lid sized and shaped to cover the first rim when placed there-on, one or more hinges pivotably connecting the lid to the sidewall and enabling the lid to pivot between an opened position for accessing the cavity and a closed position for covering the cavity, a pair of handles for carrying the appliance, opposingly disposed on a left side and a right side of the cooking chamber, and each having a latch for voluntarily securing the lid to the side wall, each latch having an unlatched position for allowing the lid to pivot relative to the sidewall, and a latched position for engaging the lid to the sidewall in the closed position, a pressure seal disposed between the lid and the first rim and compressed there-between when the lid is in the closed position and the latch is in the latched position, and a pressure-regulating valve communicating between the cavity and an exterior environment and adapted to prevent pressure within the cavity from exceeding a first predetermined pressure level relative to the exterior environment.

The appliance may further have a pressure responsive lock for involuntarily securing the lid in the closed position when the pressure within the cavity exceeds a second predetermined pressure level. The appliance may include a pan sized and shaped to fit within the cavity and having a generally hollow interior and a second rim defining a second opening for accessing the generally hollow interior. The one or more hinges, voluntary latches, and involuntary latches may be approximately equally spaced about the first rim. The appliance may further have a control for maintaining the heating of the cavity at a predetermined temperature level. The pressure-regulating valve may be adjustable to vary the predetermined pressure level. The cooking chamber may be longer from the left side to the right side than from a front side to a rear side. The one or more hinges may be disposed on the rear side.

The foregoing summary, as well as the following detailed description of the disclosure, will be better understood when read in conjunction with the appended drawings. To illustrating the disclosure, there are shown in the drawings embodiments which are presently preferred. It should be understood, however, that the disclosure is not limited to the precise arrangements and instrumentalities shown.

### BRIEF DESCRIPTION OF THE DRAWINGS

In the drawings:

FIG. 1 is a top front perspective view of a kitchen appliance according a first embodiment, wherein a lid is in a latched position;

FIG. 2 is a top front perspective view of a kitchen appliance of FIG. 1, wherein a lid is in an un-latched position;

FIG. 3 is a cross-sectional side elevational view of a kitchen appliance of FIG. 1, wherein the lid is in the latched position;

FIG. 4 is a partial cross-sectional view of the hinge detail of a kitchen appliance of FIG. 1, wherein the lid is in the closed position;

FIG. 5 is a partial cross-sectional view of the hinge detail of a kitchen appliance of FIG. 1, wherein the lid is in the open position;

FIG. 6 is a partial cross-sectional view of the hinge detail of a kitchen appliance of FIG. 1, wherein the lid is lifted off the hinge for removal;

FIG. 7 is an enlarged partial cross-sectional view of a safety lock of the kitchen appliance of FIG. 1 with the lock in its unlocked position;

FIG. 8 is an enlarged partial cross-sectional view of a safety lock of the kitchen appliance of FIG. 1 with the lock in its locked position;

FIG. 9 is an enlarged partial cross-sectional view of a pressure regulator of the kitchen appliance of FIG. 1;

FIG. 10 is an enlarged partial cross-sectional view of a pressure regulator of the kitchen appliance of FIG. 1;

FIG. 11 is a cross sectional view through a latching device used to compress the seal of the kitchen appliance of FIG. 1;

FIG. 12 is a top front perspective view of a kitchen appliance according a second embodiment, wherein a lid is in a latched position;

FIG. 13 is a cross-sectional frontal elevational view of a kitchen appliance of FIG. 12 along Lines 13-13 in FIG. 12;

FIG. 14 is a cross-sectional side elevational view of a kitchen appliance of FIG. 12 along Lines 14-14 in FIG. 12, wherein the lid is in the latched position;

FIG. 15 is a cross-sectional side elevational view of a kitchen appliance of FIG. 12 along Lines 14-14 in FIG. 12, wherein the lid is in its open position;

FIG. 16 is a partial cross-sectional view of the hinge detail of FIG. 14

FIG. 17 is a partial top front perspective view of the appliance of FIG. 12, with the lid shown as it is lowered to latch the lid in place;

FIG. 18 is a partial cross-sectional view of the appliance of FIG. 12, along the lines 18-18 of FIG. 17, where the lid lock is in its unlocked position;

FIG. 19 is a partial cross-sectional view of the appliance of FIG. 12, along the lines 18-18 of FIG. 17, where the lid lock is in its locked position;

FIG. 20 is a top front perspective view of a cooking pan of the kitchen appliance if FIG. 12; and

FIG. 21 is an enlarged partial cross-sectional view of the right-side latch shown in FIG. 13.

### DETAILED DESCRIPTION OF EXEMPLARY EMBODIMENTS

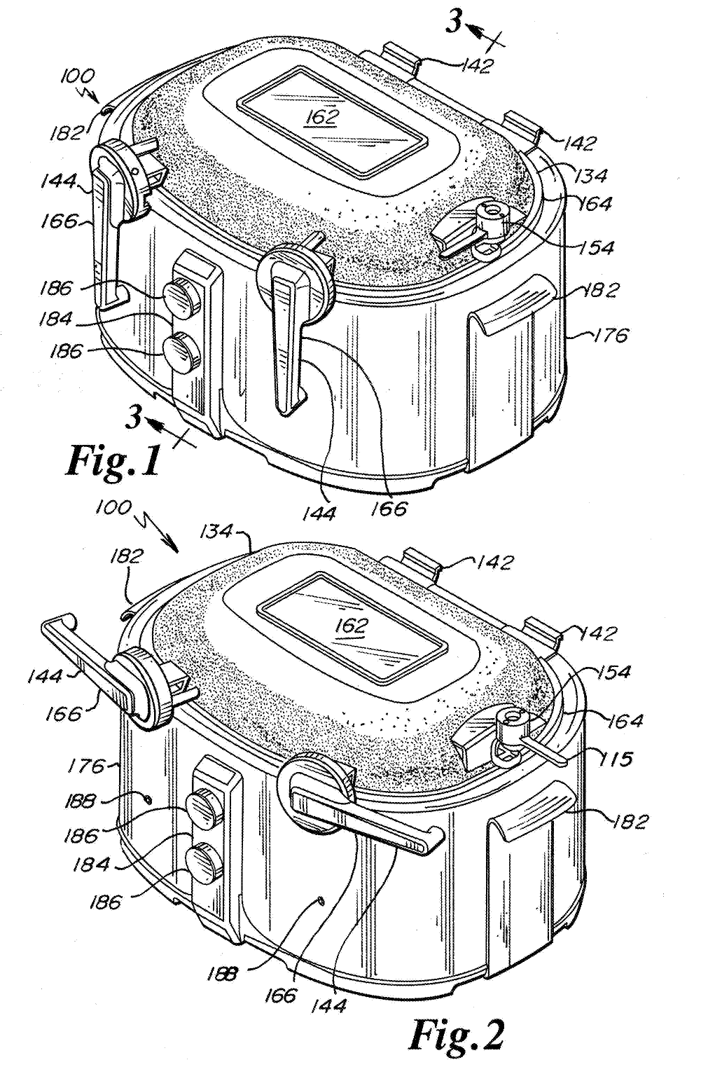

FIGS. 1 through 11 show a first exemplary embodiment of a pressure roasting appliance in accordance with or useful in practicing the invention.

The appliance 100 has a cooking chamber 102 with a base 104 with a side wall 106 extending upwardly there-from to an upper rim 108. The side wall has an exterior surface 112 and an opposing interior surface 114. At least portions of the interior surface of the side wall and base define a cavity 116 within the cooking chamber. The cooking chamber's rim 108 is disposed at a first, free upper edge of the side wall to define an opening 118 to the cavity. A heating element 122 is disposed within the cooking chamber proximate the cavity to heat the cavity. A pan 124 has a generally hollow interior 126 and a rim 128 defining an opening for accessing the interior 126. The interior of the pan can retain food contents therein. The pan is sized and shaped to fit within the cavity of the cooking chamber. A lid 134 is sized and shaped to at least partially cover the cooking chamber rim 108 when placed there-on. The lid has an exterior surface 136 and an opposing interior surface 138 facing the interior of the cooking chamber cavity when the lid is placed on the cooking chamber rim. A pair of hinges 142 and a pair of latches 144 are mounted to the exterior of the side wall of the cooking chamber and the exterior surface 136 of the lid.

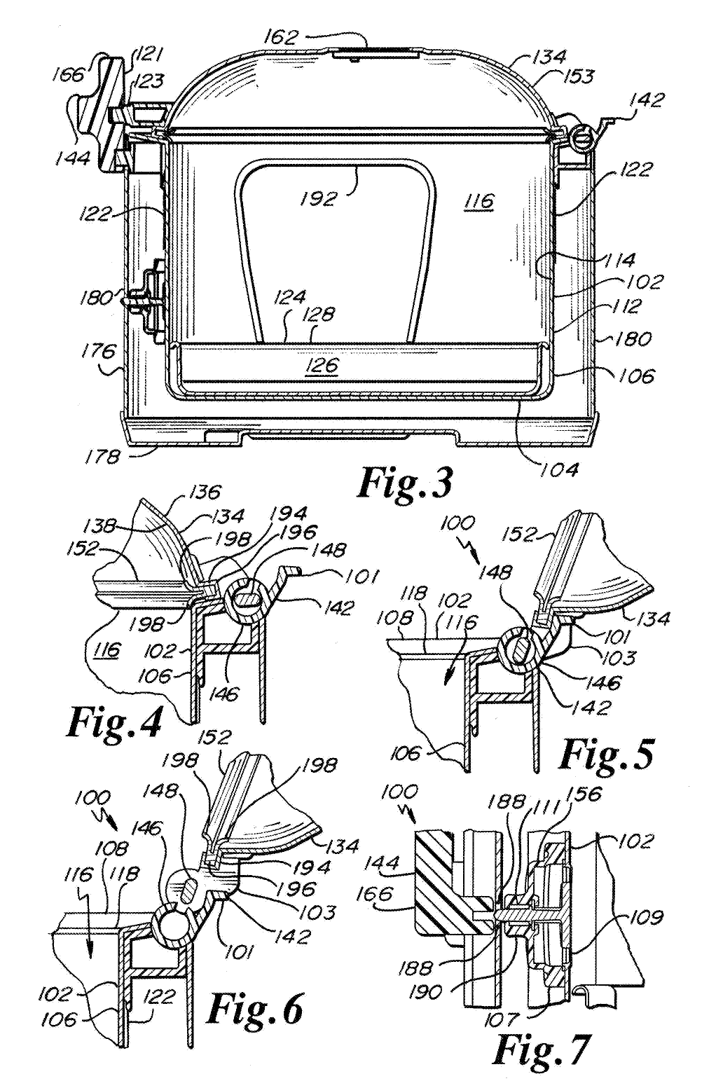

Referring to FIGS. 4 through 6, the hinges each include a stationary component 146 and a pivoting component 148. The stationary component is fashioned so that in an angular position corresponding with the lid being open the pivoting component can be slid out of the stationary component for the lid to be removed from the remainder of the appliance. A flexible seal 152 is disposed in the interface between the lid and the cooking chamber rim. The seal is compressed when the latches are rotated into their latched positions, as in FIGS. 2 and 3, to seal the cooking chamber and to maintain a pressurized atmosphere there-within when the heating element is energized and moisture within the food is vaporized.

A pressure regulating valve 154 communicates between the cooking chamber cavity and the outside atmosphere, to control the pressure built up within the cooking chamber as the food is heated and steam is generated therefrom. Pressure activated locking means 156 locks the lid to the chamber so that the lid cannot be opened as long as the pressure within the cooking chamber is greater than the atmospheric pressure outside.

FIG. 1. shows the appliance's oval shaped outer enclosure 176 with an oval shaped lid with its latches closed into their latched position, as they would be in preparation for the cooking cycle. In FIG. 2, the latches are in their opened position so that the lid can be opened to insert the pan and food into the cavity

The lid includes a domed portion 158 with a glass window 162 at its apex for viewing the food within the chamber, and a peripheral portion 164 surrounding the domed portion. The lid includes two hinge pins 148 at its back and two latch levers 166 at its front. The hinge pins fit into stationary hinge pin receivers 146 that are part of the main appliance body. The lid also includes a vent tube 168 with an aperture 172 capped by a weighted stopper 174 forming the afore-stated pressure regulating valve 154. The operation of the pressure regulating valve will be described below in greater detail.

The outer enclosure 176 has a base 178 and a side wall 180 extending upwardly there-from. The outer enclosure further has handles 182 for transporting the appliance and an enclosure 184 for the electrical controls 186 required for the operation of the appliance. Two controls are shown, which represent how the user adjusts the cooking parameters as needed. One dial controls the cooking chamber temperature and the other controls the cooking time.

FIG. 2 shows the appliance as it would appear after completion of a cooking cycle with the two latches in front in an unlatched position, and the steam vent in an open position for allowing the pressure in the appliance to return to atmospheric pressure. Also, visible in FIG. 2 are two small apertures 188 containing pins 190, which are pressure activated and used as the afore-stated safety locks for preventing the unlatching of the lid for as long as the pressure in the appliance is higher than atmospheric pressure.

FIG. 3 is a cross sectional view along lines 3-3 of FIG. 1 illustrating the outer enclosure, the cooking chamber, the pan with a handle 192 for ease of placing and removing, and the lid with its window, its seal as well as the hinge and the latch and the safety lock. Not shown is an insulation layer filling the gap between the cooking chamber and the outer enclosure. Also shown is the heater band 122 proximate the exterior face of the wall of the cooking chamber.

FIG. 4 is a partial cross-sectional view of a portion of the lid and the at least one hinge shown as the lid is in a closed position. Shown are the dome portion of the lid and the circumferential U-shaped portion 194 of the lid designed to trap the flexible seal and to add rigidity to the lid. The seal has a rigid portion 196 which is trapped in the U shaped cross section of the lid and two flexible members 198, one of which is shown leaning against the rim of the cooking chamber. That member is sealing the interior of the cooking chamber from the outside, and the pressure within the cooking chamber urges the lower flexible member against the rim. The stationary part 146 of the hinge has a rigid body secured to the wall of the cooking chamber, an incomplete cylinder for receiving the turning pin portion 148 of the hinge and an appendage 101 for supporting the lid when in an open position. The turning pin is oval in its shape with the long side slightly smaller than the diameter of the incomplete cylinder and its narrow side slightly smaller than the open portion of the incomplete cylinder.

FIG. 5 shows the hinge as seen in FIG. 4 except that the lid is hinged open and is leaning on the appendage which prevents it from opening any further. The narrow part of turning portion of the hinge is aligned with the opening of the incomplete cylinder, permitting it to be slid out by pulling on the lid.

FIG. 6 shows the hinge as seen in FIG. 4 except that the lid is shown with the turning portion of the hinge outside the incomplete cylindrical portion of the stationary portion of the hinge. FIG. 6 also allows an unobstructed view of the turning portion of the hinge shown with its turning pin connected to a plate, connected to a brace 103 which is attached to the lid.

FIG. 7 shows the pressure activate safety lock 156 including pin 190 with an elongated body, a large flat head and a rounded tapered end; the pin movement is guided by a tubular channel in a support structure 107 that is firmly attached to the wall of the cooking chamber. The cooking chamber wall has an opening that is equal in size to the open end of the tubular support structure. A high temperature flexible silicone disc 109 is trapped between the wall and the support structure thereby providing a cover for the opening in the wall of the cooking chamber. The movement of the pin is limited by stops in the inner end of the tubular channel. The pin is biased towards the silicone disc by a compression spring 111. The rounded tapered end of the pin fits through a small aperture in the wall of the outer enclosure. In FIG. 7 the pin is shown in its retracted position.

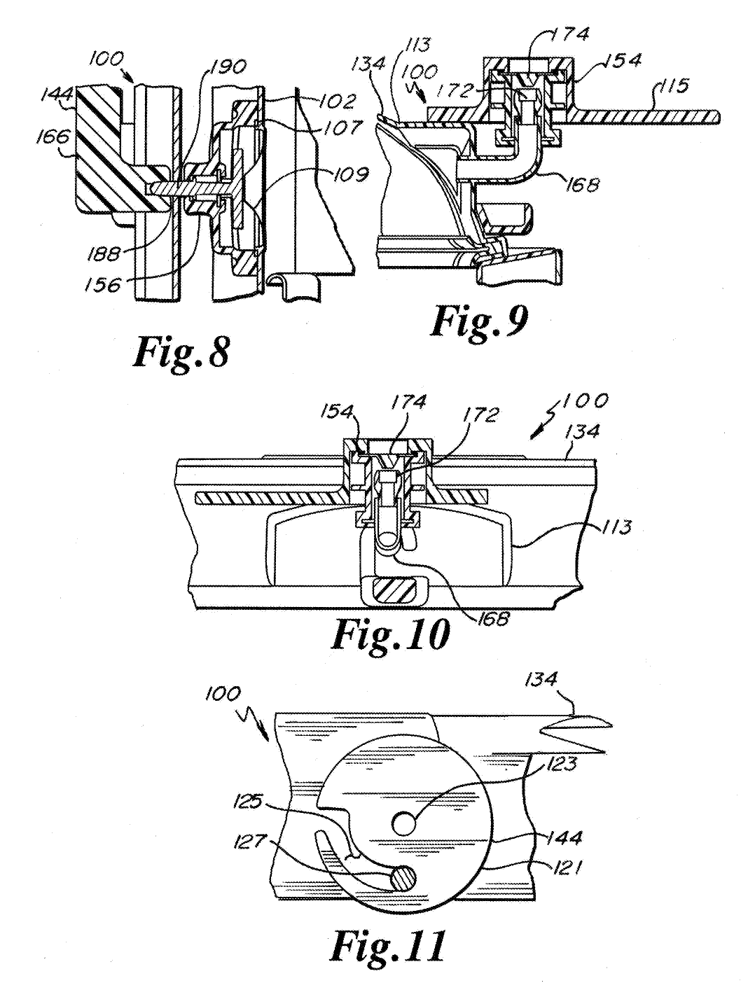

FIG. 8 shows the pressure activated safety lock in its extended position, caused by internal pressure pressing the flexible disc and thereby applying force on the pin head, overcoming the spring force and pushing the rounded tapered end to engage an opening of the latch, thereby preventing it from moving for as long as there is a pressure difference between the interior of the cooking chamber and the outside.

FIG. 9 is a partial cross-sectional view of the pressure regulating valve 154 seated on ramp 113 of the lid. Seating the regulator on the ramp is achieved by the user turning the pressure regulator handle 115 away from the lid. When the pressure regulator is seated on the ramp, the stopper portion 174 of the regulator is lifted from its seat 172 allowing steam to escape from the cooking chamber.

FIG. 10 is a partial cross-sectional view of the pressure regulator where the pressure regulator stopper portion is seated on its seat. During operation, as pressure builds up in the cooking chamber, the pressure regulator will be lifted by the force that the pressure exerts on the stopper, allowing small amounts of steam to escape from the cooking chamber thereby to maintain a pre-determined pressure in the cooking chamber. The pressure being maintained in the cooking chamber is proportional to the weight of the pressure regulator and inversely to the cross-sectional area of the seat.

FIG. 11 is a partial cross-sectional view through latch 144, which serves both the secure the lid to the cooking chamber and to compress seal 152. It consists of a disc 121 rotatable about a pin 123 attached to the lid with a slot 125 that spirally decreases its distance from the center of the disc as the disc is rotated. At one end of the slot there is an opening designed to receive pin 127 protruding from the cooking chamber. When the disc is turned by the operator the distance between the lid pin about which the disc turns and the cooking chamber pin decreases so that the lid and the cooking chamber are pulled closer to each other causing the seal (shown in FIGS. 3, 4, 5 and 6 and located between the rim of the cooking chamber and the lid) to compress.

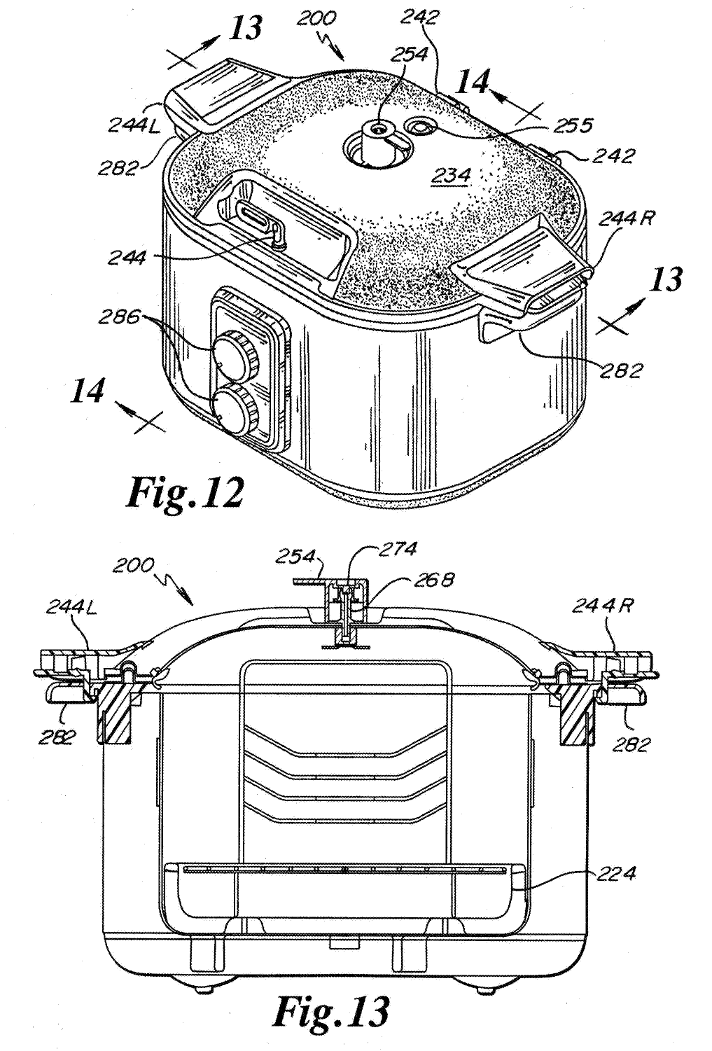

FIGS. 12 through 21 show a second exemplary appliance according to or useful in practicing the invention. This appliance shares many features with the first embodiment, so for brevity, only features which non-clearly differ therefrom will be explained. Numbering in FIGS. 12-21 is assigned to follow the same numbering pattern as in the disclosure above for FIGS. 1-11, even when items are not specifically referenced in this disclosure. For instance, the lid of the first embodiment was assigned item number 134, so the lid of FIGS. 12-21 is assigned item number 234, even though the lid and its item number may not be mentioned in the written Specification.

Appliance 200 has an oval-shaped outer enclosure with an oval shaped lid, shown in its closed and latched position in FIG. 12, as it would appear during the cooking cycle. The lid includes a domed portion, and a peripheral portion surrounding the domed portion. The lid includes two U-shaped upper portions 248 of hinge assemblies 242 at its back and a safety latch 244F at its front. The lid also includes two outwardly extending appendages 244L and 244R that include latches to engage carrying handles 282 to secure the lid to against the cooking chamber when latched. The lid also includes a vent tube 268 with an aperture 272 capped by a weighted stopper 274 forming a pressure regulating valve 254. The structure and operation of the pressure regulator valve is similar to that described above.

The lid further includes a back-up safety pressure release valve 255, of a type known in the art. The outer enclosure has a base and a side wall extending there-from, as in the first embodiment. The outer enclosure further includes an enclosure for the electrical controls required for the operation of the appliance, as in the first embodiment. Two dials are shown, which represent how the user adjusts the electrical controls of cooking time and cooking temperature, as in the first embodiment.

FIG. 13 is a cross sectional view along lines 13-13 of FIG. 12 illustrating the outer enclosure having a base portion and a side wall portion, and a cooking chamber with four raised bumps at its bottom for suspending cooking pan 224 above the bottom of the cooking chamber.

The pan, best seen in FIG. 20, incorporates a wire form rack 224F and handle 292 for ease of placing and removing it from the cooking chamber. The handle may also serve to prevent food from contacting the cooking chamber wall and getting burnt by its high temperatures. It can also be seen that the lid has an inner and outer shell, a seal a and a pressure regulating valve as in the first embodiment.

The pair of handles 282 on the left and right sides of the enclosure also serve as latch receivers for cooperating with latches 244L and 244R to hold the lid tightly in place during operation, these latch details are further shown in FIG. 21. Not shown is an insulation layer filling the gap between the cooking chamber and the outer enclosure. Also shown is the heater band 222 proximate the exterior face of the wall of the cooking chamber.

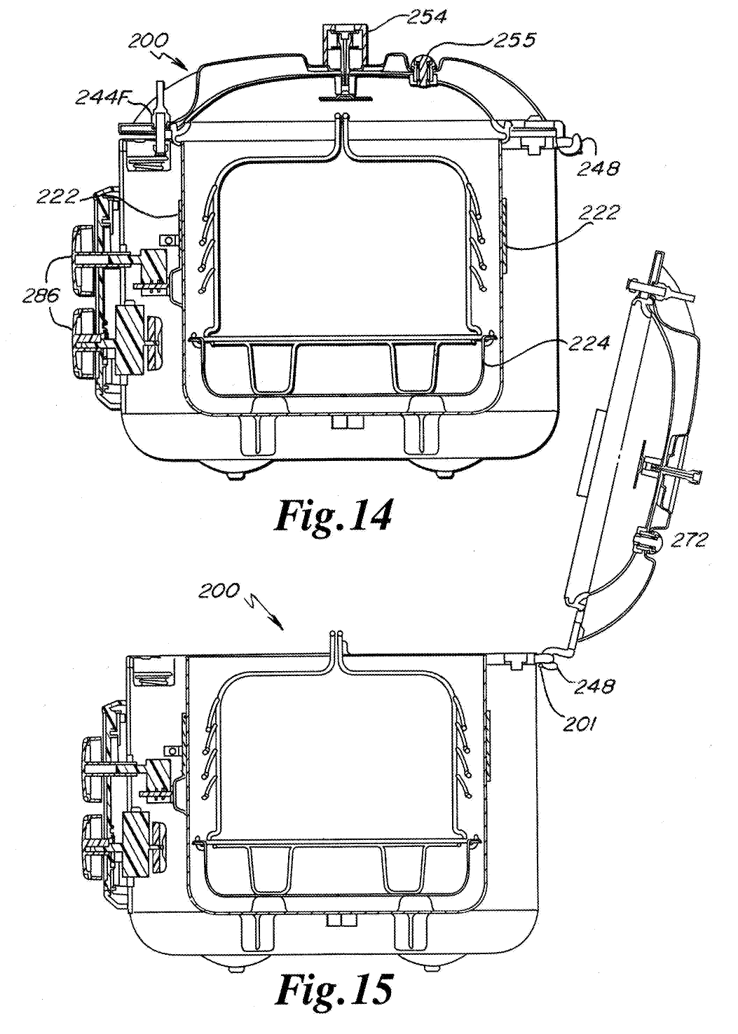

FIG. 14 is a cross sectional view along lines 14-14 of FIG. 12. Here it can be seen that the pan incorporates a wire form rack suspended from the base of the cooking pan for supporting food above the collection of fat and other liquids that may drip down during the cooking process. Also shown are the afore-mentioned thermostatic and timing controls 286.

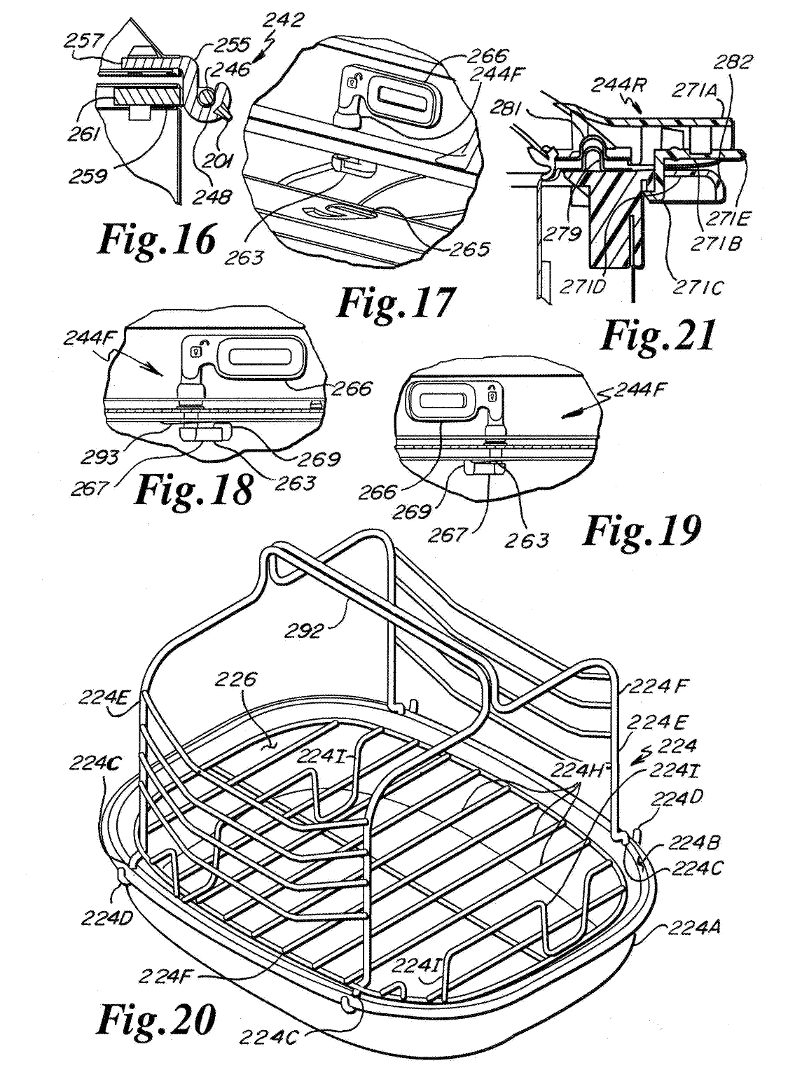

FIGS. 15 and 16 show the appliance of FIG. 14 except that the lid is open and is restrained from tilting further back by wedge 201 which is part of the hinge portion connected to the lid, which bumps up against the outer enclosure to limit the movement of the lid. Upper hinge-half 255 has flange portion 257 extending inwardly therefrom for securement to lid, and the afore-mentioned U-shaped portion 248 for engaging pin portion 246 of the lower hinge-half 259 which is secured to the rim of the cooking chamber through its own flange 261. The U-shaped portion of the upper hinge-half includes a dovetail shaped recess for firmly receiving wedge 201. The wedge may be slid out by the user to allow the hinge halves to disengage when the lid is to be removed for cleaning.

FIG. 17 shows the lid just before it is closed. Also shown is safety latch 244F, which has a key 263 and a handle 266 firmly connected to each other and rotatable together in a manner known in the art so as the handle is turned by the user the key portion turns along with it. The safety lock is rotatably secured to the outer portion of the front of the lid. Key-hole 265 in the cooking chamber rim receives key 263 when the key is in its unlatched position of FIG. 17 and the lid is closed. The rim has a ramping annular shape with its center coinciding with the center of rotation of the key. The ramp 293 has its shallow end proximate the keyhole and its deepest end terminating at approximately 150 degrees from its start. The safety lock key 263 has an arm 267 and a pad 269, slightly raised from the upper face of the arm portion. The pad portion is arranged to ride along the ramp as the user turns the handle in a clockwise position. when the lock is turned to the end of its travel, the pad no longer rides on the slope, and is blocked from turning back, unless the handle is forcibly depressed. This serves as a pressure-activated safety lock that ensures that when the cooking compartment is pressurized, the pressure will create an upward force on pad 269, equal to the pressure multiplied by the cross-sectional area of the lid, which the user will have to overcome to push the safety lock downwards for the pad to clear the lowest part of the ramp, so it can be slid back to its unlocked position. For example, if the internal pressure were to be 2 PSI and the lid were to be 200 square inches then the force on the lid would equal 400 lbs. the user will have to wait until all the internal pressure is relieved through the pressure relieve valve before unlocking the safety lock.

FIG. 18 is a partial cross-sectional view showing the lid in its closed position with the safety lock disengaged. In FIG. 19, the safety lock is shown in its locked and secured position where the key pad is partially hidden behind the ramp of the rim. FIGS. 18 and 19 both show the ramping of the rim, as well as the open and locked icons on the key handle.

FIG. 20 shows pan 224 in greater detail. The assembly has a metal pan portion 224A which may be non-stick coated to assist in cleaning after use. The pan features a cavity 226 surrounded by a sidewall terminating at its top in a flanged rim 224B with four small apertures 224C for removably containing loops 224D at the ends of two symmetrical carrying handle assemblies 224E, which may be made of steel wires, formed and welded into a shape which includes an outer frame with cross members positioned to create a fence to prevent chicken wings and thighs from contacting the hot walls of the cooking chamber. The two carrying handle assemblies come together at their tops to form handle 292, but may be swung away from each other to access cavity 226. Rack 224F may be made of loops of steel wire with several cross braces welded thereto. The rack fits into cavity 226 to suspend food off the bottom of the pan. Two of the cross braces 224H of the rack are bent to form support legs 2241 for keeping the rack off the bottom of the pan, where oil and other drippings may accumulate.

FIG. 21 is an enlarged partial cross-sectional view through latch 244R (representing also latch 224L). The latch is used to firmly hold the lid to the cooking chamber thereby compressing the seal to avoid loss of pressure. The latch consists of an upper portion firmly attached to the lid (in a manner known in the art) and a handle 282 firmly attached to the rim of the cooking chamber (in a manner known in the art). The upper portion consists of a stationary portion 271A and a hinged portion 271B. The hinged portion includes a spring-biased hook 271C. Slot 271D of handle 282 receives the hook as the lid is closed so that the hook captures the handle upward pressure against the opposite end 271E of the hook, against the spring bias, allows the hook to release from the lid.

FIG. 21 also shows an alignment pair including convex bump 279 of the cooking chamber rim fitting into concave pocket 281 of the lid. One such alignment pair is located near each of the side latches 244R and 244L. More or such alignment pairs may be used around the rim to ensure that latches are being aligned independently of manufacturing tolerances that are typical to sheet metal manufacturing techniques. This ensures that the lid and the cooking chamber are pulled as close together as possible, thereby causing the seal (shown in FIGS. 3, 4, 5 and 6) located between the rim of the cooking chamber and the lid to be fully compressed.

It should be understood that while the invention has been shown and described with reference to the specific exemplary embodiments shown, various changes in form and detail may be made without departing from the spirit and scope of the invention, and that the invention should therefore only be limited according to the following claims, including all equivalent interpretation to which they are entitled.

I claim:

A1. A countertop kitchen appliance comprising:
a cooking chamber having a side wall and a first rim defining a first opening to a cavity;
an electric heating element disposed proximate the cavity to heat the cavity;
a lid sized and shaped to cover the first rim when placed there-on;
one or more hinges pivotably connecting the lid to the sidewall and enabling the lid to pivot between an opened position for accessing the cavity and a closed position for covering the cavity;
one or more latches for voluntarily securing the lid to the side wall, each having an unlatched position for allowing the lid to pivot relative to the sidewall, and a latched position for engaging the lid to the sidewall in the closed position;
a pressure seal disposed between the lid and the first rim and compressed there-between when the lid is in the closed position and the latch is in the latched position; and
a pressure-regulating valve communicating between the cavity and an exterior environment and adapted to prevent pressure within the cavity from exceeding a first predetermined pressure level relative to the exterior environment.

2. The countertop kitchen appliance of claim 1 further comprising a pressure responsive lock for involuntarily securing the lid in the closed position when the pressure within the cavity exceeds a second predetermined pressure level.

3. The countertop kitchen appliance of claim 2 further comprising pan sized and shaped to fit within the cavity and having a generally hollow interior and a second rim defining a second opening for accessing the generally hollow interior;

4. The countertop kitchen appliance of claim 3 wherein the one or more latches is at least two latches, and wherein the one or more hinges and at least two latches are approximately equally spaced about the first rim.

5. The countertop kitchen appliance of claim 4 further comprising a control for maintaining the heating of the cavity at a predetermined temperature level.

6. The countertop kitchen appliance of claim 5 wherein the pressure-regulating valve is adjustable to vary the predetermined pressure level.

7. The countertop kitchen appliance of claim 4 wherein the pressure-regulating valve is adjustable to vary the predetermined pressure level.

8. The countertop kitchen appliance of claim 2 wherein the appliance is longer from a left side to a right side than from a front side to a rear side.

9. The countertop kitchen appliance of claim 8 wherein the one or more latches is at least two latches, and wherein the one or more hinges and at least two latches are approximately equally spaced about the first rim.

10. The countertop kitchen appliance of claim 9 wherein the at least two latches is two latches disposed adjacent the left and right sides and the one or more hinges are disposed on the rear side.

11. The countertop kitchen appliance of claim 10 further comprising a control for maintaining the heating of the cavity at a predetermined temperature level.

12. The countertop kitchen appliance of claim 11 wherein the pressure-regulating valve is adjustable to vary the predetermined pressure level.

13. The countertop kitchen appliance of claim 10 wherein the pressure-regulating valve is adjustable to vary the predetermined pressure level.

14. A countertop kitchen appliance comprising:
a cooking chamber having a side wall and a first rim defining a first opening to a cavity;
an electric heating element disposed proximate the cavity to heat the cavity;
a lid sized and shaped to cover the first rim when placed there-on;
one or more hinges pivotably connecting the lid to the sidewall and enabling the lid to pivot between an opened position for accessing the cavity and a closed position for covering the cavity;
a pair of handles for carrying the appliance, opposingly disposed on a left side and a right side of the cooking chamber, and each comprising a latch for voluntarily securing the lid to the side wall, each latch having an unlatched position for allowing the lid to pivot relative to the sidewall, and a latched position for engaging the lid to the sidewall in the closed position;
a pressure seal disposed between the lid and the first rim and compressed there-between when the lid is in the closed position and the latch is in the latched position; and
a pressure-regulating valve communicating between the cavity and an exterior environment and adapted to prevent pressure within the cavity from exceeding a first predetermined pressure level relative to the exterior environment.

15. The countertop kitchen appliance of claim 14 further comprising a pressure responsive lock for involuntarily securing the lid in the closed position when the pressure within the cavity exceeds a second predetermined pressure level.

16. The countertop kitchen appliance of claim 15 further comprising pan sized and shaped to fit within the cavity and having a generally hollow interior and a second rim defining a second opening for accessing the generally hollow interior;

17. The countertop kitchen appliance of claim 16 wherein the one or more hinges, voluntary latches, and involuntary latches are approximately equally spaced about the first rim.

18. The countertop kitchen appliance of claim 17 further comprising a control for maintaining the heating of the cavity at a predetermined temperature level.

19. The countertop kitchen appliance of claim 18 wherein the pressure-regulating valve is adjustable to vary the predetermined pressure level.

20. The countertop kitchen appliance of claim 17 wherein the pressure-regulating valve is adjustable to vary the predetermined pressure level.

21. The countertop kitchen appliance of claim 15 wherein the cooking chamber is longer from the left side to the right side than from a front side to a rear side.

22. The countertop kitchen appliance of claim 21 wherein the one or more hinges, voluntary latches, and involuntary latches are approximately equally spaced about the first rim.

23. The countertop kitchen appliance of claim 22 wherein the one or more hinges are disposed on the rear side.

24. The countertop kitchen appliance of claim 23 further comprising a control for maintaining the heating of the cavity at a predetermined temperature level.

25. The countertop kitchen appliance of claim 24 wherein the pressure-regulating valve is adjustable to vary the predetermined pressure level.

26. The countertop kitchen appliance of claim 23 wherein the pressure-regulating valve is adjustable to vary the predetermined pressure level.
